(19) United States
(12) Patent Application Publication
(10) Pub. No.: US 2004/0238270 A1
(43) Pub. Date: Dec. 2, 2004

(54) Noise elimination device for a table height adjustment

(76) Inventor: Shih-Lin Chang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/449,063

(22) Filed: Jun. 2, 2003

(51) Int. Cl. F16F 7/00; F16F 15/00

(52) U.S. Cl. 181/207; 181/209

(57) ABSTRACT

A noise elimination device for a table height adjustment includes a base, a tabletop, an engaging member, and a noise eliminating plate. The base has a lower pipe extending from one end upwardly, and the tabletop has an upper pipe extending downward from one end. The engaging member is mounted in the lower end of the upper pipe, which then is inserted into the lower pipe of the base. The engaging member has a hole with a fixed plate underneath. The noise eliminating plate is made of soft material and secured on the top of the fixed plate with a scratching end at one end thereof to engage with the inner wall of the lower pipe when moving the upper pipe of the tabletop within the lower pipe in a silent way.

### FIELD OF THE INVENTION

This invention relates to a noise elimination device for a table height adjustment, and more particularly, to a soft noise eliminating plate engaging with the inner wall of the pipe to eliminate any noise caused by moment.

### BACKGROUND OF THE INVENTION

A conventional table used at most hospital wards is the kind that the height is adjustable, as shown in FIGS. 7˜9. This table comprises a tabletop A, an upper pipe B, a lower pipe C and a roller base D. The connecting area between the tabletop A and the upper pipe B has a knob B1 linking to a push rod B2, which is inserted into the upper pipe B. The upper pipe B is mounted within the lower pipe C in a retractable manner. The bottom end of the push rod B2 engages with the top end of a fixed plate B3 in an engaging member B3. The fixed plate B4 is made of metal material with an engaging end B5 at one end, which engages with the inner wall of the lower pipe C to secure the upper pipe B at place. To move the upper pipe B, the knob B1 is pressed down to push the push rod B2 downward, which in turn pushes the fixed plate B4 downward to slant towards one direction whereas the engaging end B5 is disengaged with the inner wall of the lower pipe C, and the upper pipe B is able to move within the lower pipe C by the elasticity of a spiral spring B6. When the pushing force from the knob B1 is released, a spring B7 urges the fixed plate B4 to return to its original position and engage with the inner wall of the lower pipe C to stop the moving of the upper pipe B. The fixed plate B4 is made of metal material. When the upper pipe B is moved in the lower pipe C, the engaging end B5 may touch the inner wall of the lower pipe C and produce squeaking sound.

### SUMMARY OF THE INVENTION

It is the primary of the present invention to provide a noise elimination device for a table height adjustment, which eliminates the noise caused by movement between the fixed plate and the inner wall of the lower pipe.

It is another object of the present invention to provide a noise elimination device for a table height adjustment, which is easy to install.

It is a further object of the present invention to provide a noise elimination device foe a table height adjustment, which is easy to maintain and inexpensive.

### BRIEF DESCRIPTION OF THE DRAWING

FIG. 1 is a perspective view of the present invention;

FIG. 2 is an exploded view of the present invention;

FIG. 3 is a side cross-sectional view depicting the relative structure of the present invention;

FIG. 4 is a side cross-sectional view of a knob and the structure of the present invention;

FIG. 5 is a side cross-sectional view of a first embodiment of the present invention in an operating status;

FIG. 6 is a side cross-sectional view of a second embodiment of the present invention in an operating status;

FIG. 7 is a perspective view of a conventional table;

FIG. 8 is an exploded view of FIG. 7; and FIG. 9 is a side cross-sectional view of FIG. 7 in an operating status.

### DETAILED DESCRIPTION OF THE PREFERRED EMBODIMENTS

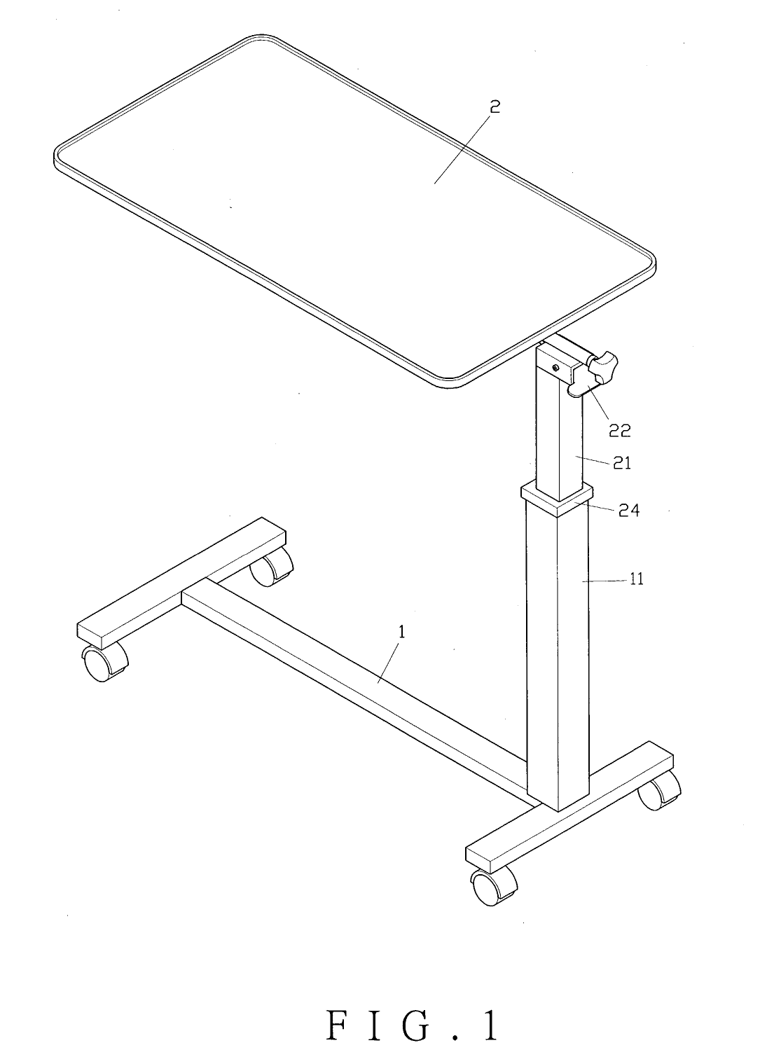

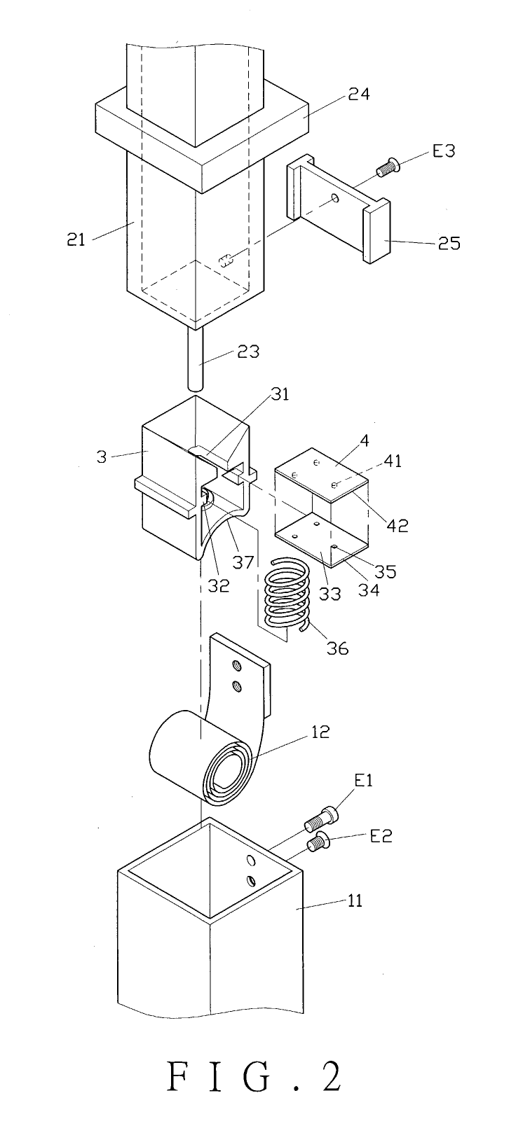

As shown in FIGS. 1 and 2, the present invention comprises a base 1, a tabletop 2, an engaging member 3, and a noise eliminating plate 4.

The base 1 comprises a lower pipe 11 extending upwardly from one end thereof A spiral spring 12 is secured in the upper end of the lower pipe 11 by means of fasteners E1 and E2.

The tabletop 2 comprises an upper pipe 21 extending downwardly from one end thereof and a knob 22 between the tabletop 2 and the upper pipe 21. The knob 22 links to a push rod 23 extending one end into the upper pipe 21. The upper pipe 21 has a ridge 24 at the lower end thereof and is secured with a washer 25 by a fastener E3 thereat, and is inserted into the top portion of the lower pipe 11.

The engaging member 3 is embedded in the bottom of the upper pipe 21 and comprises a hole 31 with a pair of ribs 32 underneath. The ribs 32 support a fixed plate 33 at its top portion. The fixed plate 33 comprises an engaging end 34 at one end and a plurality of locating holes 35 on the top thereof. A spring 36 is seated under the fixed pate 33. The engaging member 3 further comprises an arcuate base 37 at the bottom end thereof.

The noise eliminating plate 4 is secured on the fixed plate 33. The noise eliminating plate 4 is made of plastic or rubber material, and comprises a plurality of tabs 41 and a scratching end 42 at one end.

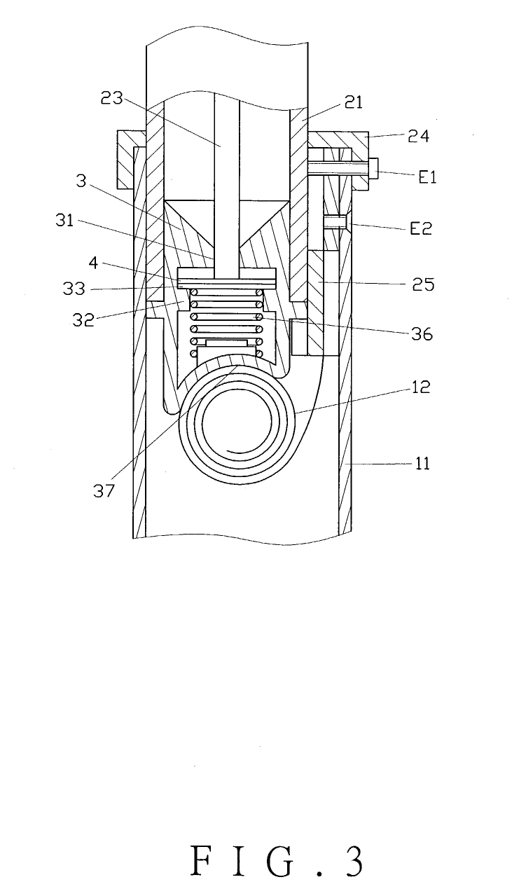

To assemble the present invention, as shown in FIG. 3, the noise eliminating plate 4 is placed on the top of the fixed plate 33 with the tabs 41 inserting into the locating holes 35, then the fixed plate 33 is placed on the two ribs 32 of the engaging member 3 and engaged with the top of the spring 36. The push rod 23 is urged by the knob 22 to press the noise eliminating plate 4 and the fixed plate 33, then the upper pipe 21 of the tabletop 2 is inserted into the lower pipe 11 of the base 1 with the arcuate base 37 seating on the spiral spring 12 while the engaging end 34 of the fixed plate 33 engages with the inner wall of the lower pipe 11 to prevent the upper pipe 21 from moving within the lower pipe 11.

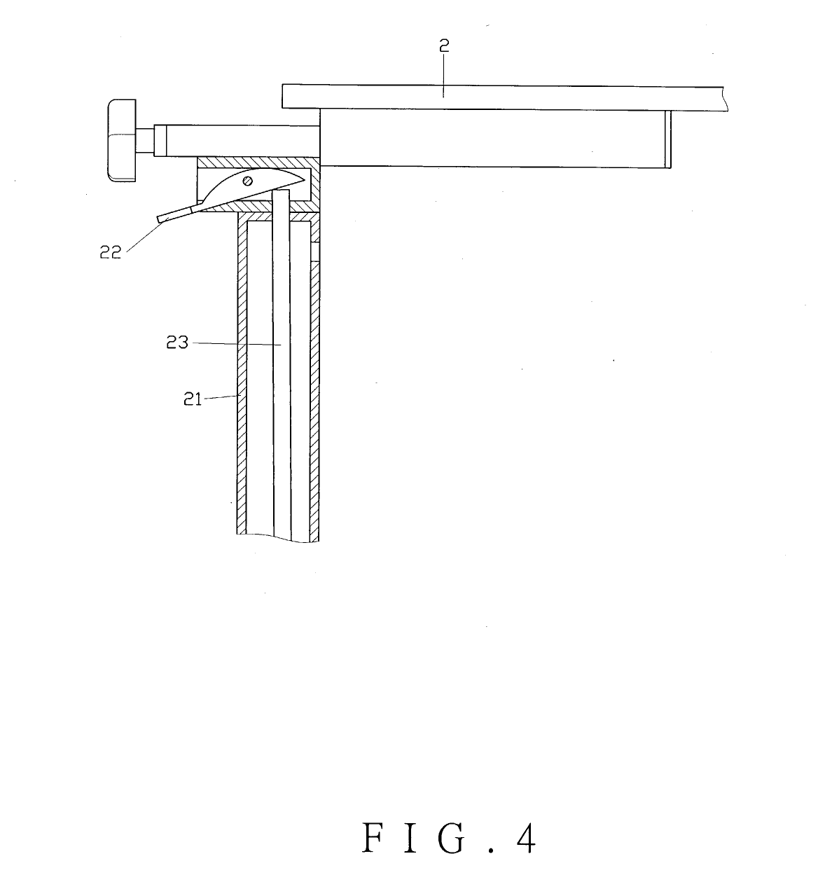

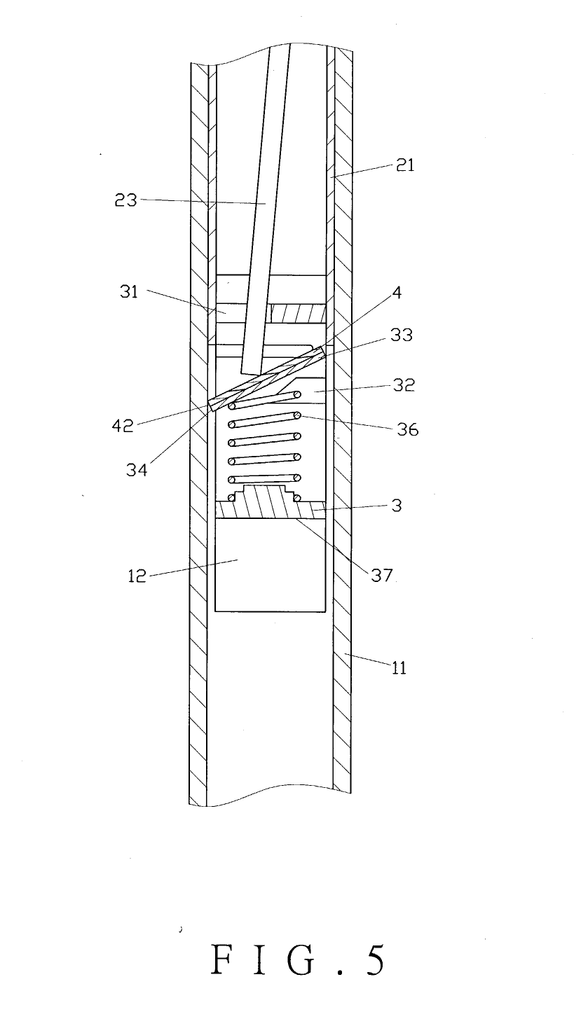

To adjust the height of the tabletop 2, the knob 22 of the tabletop 2 is pushed down, as shown in FIGS. 4 and 5, to push the push rod 23 into the hole 31 of the engaging member 3 and press the noise eliminating plate 4 and the fixed plate 33 in a slanting status. This slanting status allows the engaging end 34 of the fixed plate 33 to disengage and the scratching end 42 of the noise eliminating plate 4 to engage with the inner wall of the lower pipe 11, thus the upper pipe 21 is able to move within the lower pipe II freely. When moving downward, the engaging member 3 pulls the spiral spring 12 while when moving upward, the spiral spring 12 restores to its original position to provide with an urging force to the upward movement. Due to the soft material of the scratching end 42 of the noise eliminating plate 4, the upward movement of the upper pipe 21 will not produce any noise. When the movement stops, the knob 22 is released, which releases the push rod 23 and in turn releases the noise eliminating plate 4 and the fixed plate 33. The restoring force of the spring 36 urges the fixed plate 33 to its original position with the engaging end 34 engaging with the inner wall of the lower pipe 11, which prevents the upper pipe 21 from moving again.

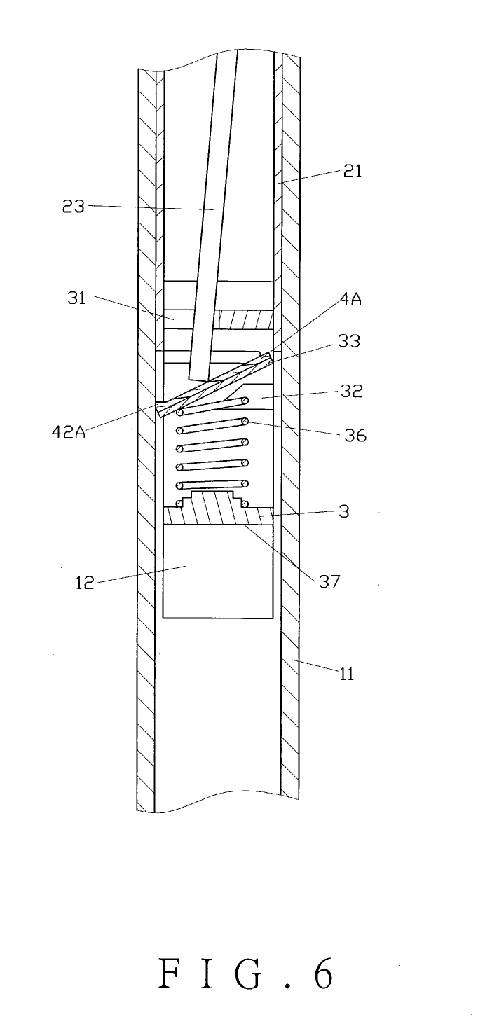

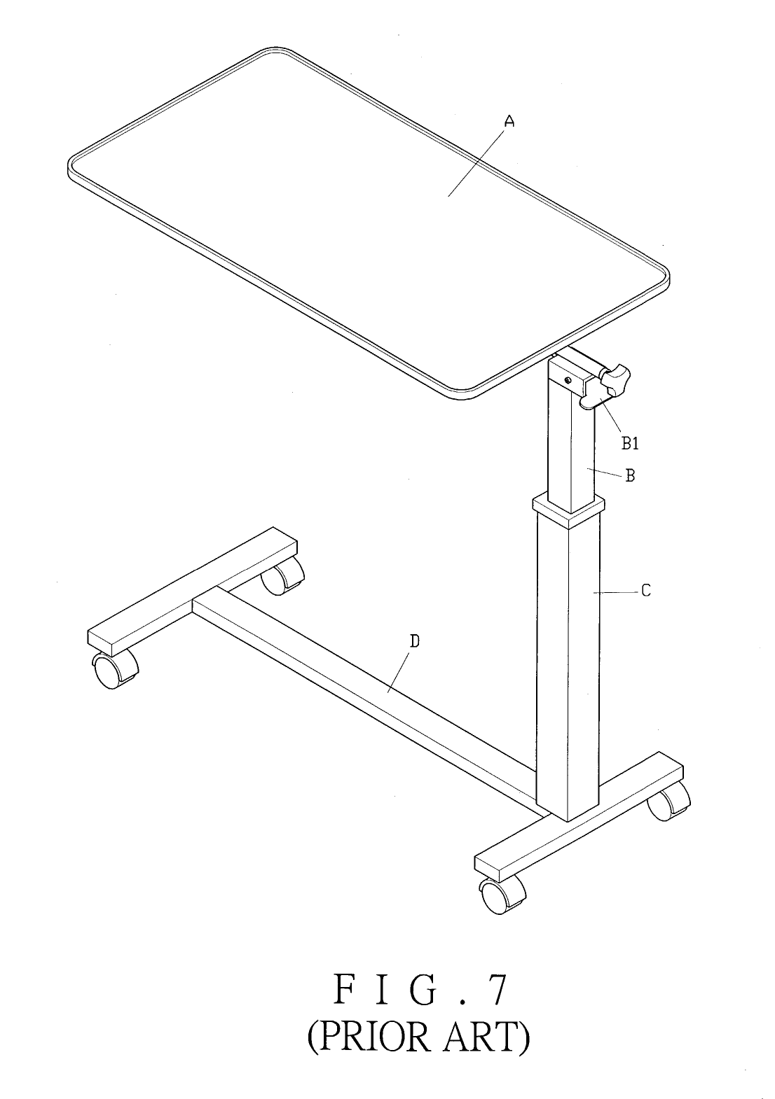

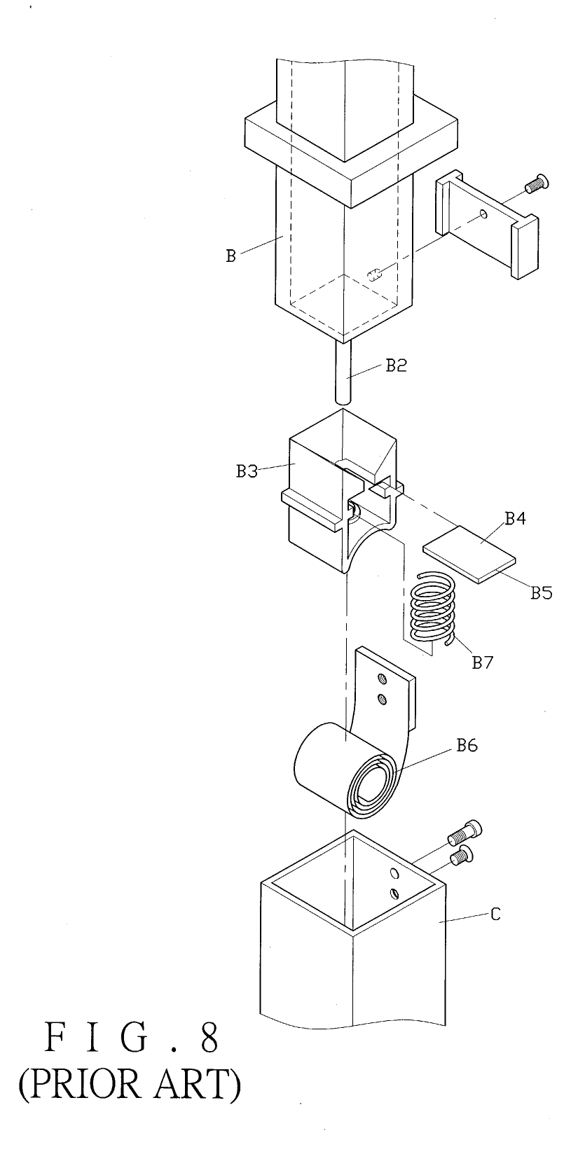

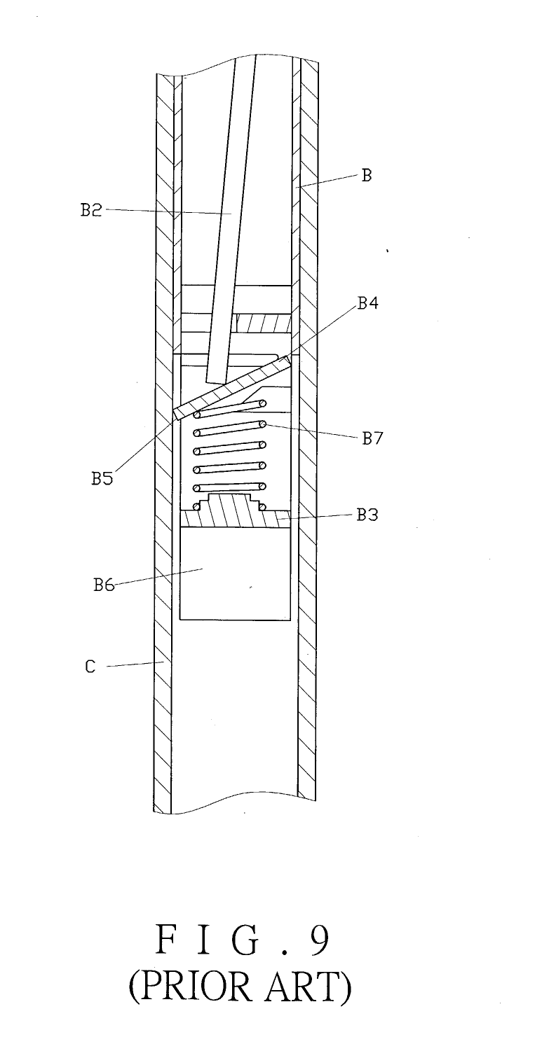

FIG. 6 shows another embodiment, which has a slanting surface of the scratching end 42A of the noise eliminating plate A protruding from the noise eliminating plate A, that provides a better contact with the inner wall of the lower pipe 11 and produces a best silencing effect.

I claim:

1. A noise elimination device for a table height adjustment comprising
a base having a lower pipe extending upwardly from one end, said lower pipe secured with a spiral spring therein;
a tabletop having an upper pipe extending downwardly from one end thereof, a knob being connected between said tabletop and said upper pipe, a push rod being linked with said knob having one end inserted into said upper pipe,
an engaging member being inserted into a lower end of said upper pipe, said engaging member comprising a hole to accommodate a fixed plate therein, said fixed plate having an engaging end, a spring being seated under said fixed plate, and characterized by that:
a noise eliminating plate being secured on an upper end of said fixed plate, said noise eliminating plate being made of soft material and comprising a scratching end thereof.

2. The noise elimination device for a table height adjustment, as recited in claim 1, wherein said fixed plate comprises a plurality of locating holes thereof, and said noise eliminating plate comprises a plurality of tabs facing downwardly and in correspondence with said locating holes of said fixed plate.

3. The noise elimination device for a table height adjustment, as recited in claim 1, wherein said scratching end of said noise eliminating plate protrudes from said noise eliminating plate and is shaped in a slanting status.
